(19) United States
(12) Patent Application Publication
(10) Pub. No.: US 2006/0195981 A1
(43) Pub. Date: Sep. 7, 2006

(54) Freestanding combination sink and hose reel workstation

(75) Inventor: Zvi Yemini, Yafo (IL)

Correspondence Address: MARK FRIEDMAN LTD.;c/o Bill Polkinghorn, 9003 Florin Way, Upper Marlboro, MD, 20772, US

(73) Assignee: HYDRO-INDUSTRIES TYNAT LTD.

(21) Appl. No.: 11/068,794

(22) Filed: Mar. 2, 2005

(51) Int. Cl. B08B 3/02

(52) U.S. Cl. 4/643; 134/34; 134/172; 134/198; 134/201

(57) ABSTRACT

A freestanding combination sink and hose reel that can be arranged in a compact storage configuration. In the compact storage configuration, the overall dimensions of the workstation are similar to the outer dimensions of the sink element. The rotatable hose reel is configured so as to In a preferred embodiment, the hose reel is configured with flanges that include a foldable section, thereby decreasing the peripheral contour of the hose reel thereby allowing for a hose reel with a flange diameter that is only slightly less than the interior length of the sink basin.

### FIELD AND BACKGROUND OF THE INVENTION

The present invention relates to portable sinks and, in particular, it concerns a freestanding combination sink and hose reel that can be arranged in a compact storage configuration.

It is known to provide freestanding portable sinks. U.S. Pat. No. 6,427,259 to Cawthon, discloses such a sink with folding legs. U.S. Pat. Nos. 6,611,972, D489,155, and D461,941 to Underbrink, et al. disclose a sinks deployed on wheeled carts with stationary legs. U.S. Pat. No. 6,611,972 also discloses a variation of the sink that is further described in U.S. Pat. No. D461,880 to Underbrink. This sink is permanently attached to a wall. It also includes a rack for storing a length of garden hose.

The prior art does not disclose a freestanding combination sink and hose reel that can be broken down to a compact storage configuration.

There is therefore a need for and freestanding combination sink and hose reel that can be arranged in a compact storage configuration. It would be beneficial if when in the compact storage configuration the hose reel were to nest inside the sink basin.

### SUMMARY OF THE INVENTION

The present invention is a freestanding combination sink and hose reel that can be arranged in a compact storage configuration.

According to the teachings of the present invention there is provided a freestanding combination sink and hose reel workstation comprising: a) a sink element having a sink basin; b) a rotatable hose reel for storage of a length of hose; and c) a plurality of legs configured to form a workstation stand that supports the sink element and the rotatable hose reel.

According to a further teaching of the present invention, the plurality of legs are configured such that in an assembled state the workstation is freestanding.

According to a further teaching of the present invention, a height, width and length of the workstation in a compact storage configuration are substantially within a range of 0-20 percent greater than a height, width and length of the sink element.

According to a further teaching of the present invention, in the compact storage configuration the hose reel is nested in the sink basin.

According to a further teaching of the present invention, the plurality of legs are configured as a plurality of leg segments detachably connected to the sink element such that in the compact storage configuration at least a portion of the plurality of leg segments are nested in the sink basin and a remainder of the plurality of leg segments are stowed substantially adjacent to an exterior of the sink basin.

According to a further teaching of the present invention, the hose reel includes a hose reel support frame, and the hose reel support frame and the plurality of leg segments cooperate to form the workstation stand, the hose reel support frame being supported so as to allow rotation of the hose reel.

According to a further teaching of the present invention, at least a portion of the hose reel support frame forms at least a portion of at least one leg of the workstation stand.

According to a further teaching of the present invention, each of four corners of the hose reel support frame form at least a portion of each of four legs of the workstation stand.

According to a further teaching of the present invention, the hose reel is configured with: a) a hose reel support frame; and b) a reel rotatably attached to the frame so as to be rotatable about an axis of rotation, the reel including: i) a drum circumscribing the axis of rotation for receiving a length of hose coiled thereabout; and ii)a pair of flanges, one of the flanges being attached to, or integrally formed with, each of a first side and a second side of the drum, each of the flanges having a fixed portion rigidly associated with the drum and at least one foldable portion hinged to the fixed portion so as to be displaceable between a folded state and a deployed state; wherein a length of the fixed portion of the flanges is less than an interior length of the sink basin and a height of the fixed portion of the flanges is less than an interior width of the sink basin such that the foldable portion of the flanges are displaced to the folded state when the hose reel is nested in the sink basin.

According to a further teaching of the present invention, a distance between outer surfaces of each of the flanges is less than the interior depth of the sink basin.

According to a further teaching of the present invention, each of the flanges has two of the foldable portions hinged to the fixed portion along substantially parallel hinges on opposite sides of the axis.

There is also provided according to the teachings of the present invention, a freestanding combination sink and hose reel workstation comprising: a) a sink element having a sink basin; and b) a rotatable hose reel for storage of a length of hose, the hose reel detachably linked to the sink element; wherein in a compact storage configuration the hose reel is nested in the sink basin.

According to a further teaching of the present invention, a height, width and length of the workstation in the compact storage configuration are substantially within a range of 0-20 percent greater than a height, width and length of the sink element.

According to a further teaching of the present invention, there is also provided, a plurality of leg segments detachably connected to the sink element such that in the compact storage configuration at least a portion of the plurality of leg segments are nested in the sink basin and a remainder of the plurality of leg segments are stowed substantially adjacent to an exterior of the sink basin.

According to a further teaching of the present invention, the plurality of legs are configured such that in an assembled stated the workstation is freestanding.

According to a further teaching of the present invention, the hose reel includes a hose reel support frame, and the hose reel support frame and the plurality of leg segments cooperate to form a workstation stand.

The workstation of claim 16, According to a further teaching of the present invention, frame forms at least a portion of at least one leg of the workstation stand.

According to a further teaching of the present invention, each of four corners of the hose reel support frame form at least a portion of each of four legs of the workstation stand.

According to a further teaching of the present invention, the hose reel is configured with: a) a hose reel support frame; and b) a reel rotatably attached to the frame so as to be rotatable about an axis of rotation, the reel including: i) a drum circumscribing the axis of rotation for receiving a length of hose coiled thereabout; and ii) a pair of flanges, one of the flanges being attached to, or integrally formed with, each of a first side and a second side of the drum, each of the flanges having a fixed portion rigidly associated with the drum and at least one foldable portion hinged to the fixed portion so as to be displaceable between a folded state and a deployed state; wherein a length of the fixed portion of the flanges is less than an interior length of the sink basin and a height of the fixed portion of the flanges is less than an interior depth of the sink basin such that the foldable portion of the flanges are displaced to the folded state when the hose reel is nested in the sink basin.

According to a further teaching of the present invention, each of the flanges has two of the foldable portions hinged to the fixed portion along substantially parallel hinges on opposite sides of the axis.

There is also provided according to the teachings of the present invention, a freestanding combination sink and hose reel workstation comprising: a) a sink element having a sink basin; b) a rotatable hose reel for storage of a length of hose, the hose reel detachably linked to the sink element, the hose reel configured with a motor configured to actuate automatic winding of a length of hose coiled thereabout; and c) a workstation stand that supports the sink element and the rotatable hose reel.

According to a further teaching of the present invention, the motor is driven by water pressure.

According to a further teaching of the present invention, in a compact storage configuration the hose reel is nested in the sink basin.

According to a further teaching of the present invention, a height, width and length of the workstation in the compact storage configuration are substantially within a range of 0-20 percent greater than a height, width and length of the sink element.

According to a further teaching of the present invention, there is also provided, a plurality of leg segments detachably connected to the sink element such that in the compact storage configuration at least a portion of the plurality of leg segments are nested in the sink basin and a remainder of the plurality of leg segments are stowed substantially adjacent to an exterior of the sink basin.

According to a further teaching of the present invention, the hose reel includes a hose reel support frame, and the hose reel support frame and the plurality of leg segments cooperate to form the workstation stand.

According to a further teaching of the present invention, the hose reel is configured with: a) a hose reel support frame; and b) a reel rotatably attached to the frame so as to be rotatable about an axis of rotation, the reel including: i) a drum circumscribing the axis of rotation for receiving a length of hose coiled thereabout; and ii) a pair of flanges, one of the flanges being attached to, or integrally formed with, each of a first side and a second side of the drum, each of the flanges having a fixed portion rigidly associated with the drum and at least one foldable portion hinged to the fixed portion so as to be displaceable between a folded state and a deployed state; wherein a length of the fixed portion of the flanges is less than an interior length of the sink basin and a height of the fixed portion of the flanges is less than an interior depth of the sink basin such that the foldable portion of the flanges are displaced to the folded state when the hose reel is nested in the sink basin.

There is also provided according to the teachings of the present invention, a method for arranging a combination sink and hose reel workstation in compact storage configuration, the method comprising: a) providing a breakdown workstation including: i) a sink element having a sink basin; and ii) a rotatable hose reel for storage of a length of hose, the hose reel detachably linkable to the sink element; and b) nesting the rotatable hose reel into an interior volume of the sink basin.

According to a further teaching of the present invention, the nesting is implemented such that a height, width and length of the compact storage configuration are substantially within a range of 0-20 percent greater than a height, width and length of the sink element.

According to a further teaching of the present invention, there is also provided a plurality of leg segments, and nesting at least a portion of the plurality of leg segments in the sink basin and stowing a remainder of the plurality of leg segments substantially adjacent to an exterior of the sink basin.

According to a further teaching of the present invention, the hose reel is implemented with: a)a hose reel support frame; and b) a reel rotatably attached to the frame so as to be rotatable about an axis of rotation, the reel including: i) a drum circumscribing the axis of rotation for receiving a length of hose coiled thereabout; and ii) a pair of flanges, one of the flanges being attached to, or integrally formed with, each of a first side and a second side of the drum, each of the flanges having a fixed portion rigidly associated with the drum and at least one foldable portion hinged to the fixed portion so as to be displaceable between a folded state and a deployed state; wherein a length of the fixed portion of the flanges is less than an interior length of the sink basin and a height of the fixed portion of the flanges is less than an interior depth of the sink basin such that the foldable portion of the flanges are displaced to the folded state when the hose reel is nested in the sink basin.

### BRIEF DESCRIPTION OF THE DRAWINGS

The invention is herein described, by way of example only, with reference to the accompanying drawings, wherein:

FIG. 1 is an isometric view of a preferred embodiment of the workstation constructed and operative according to the teachings of the present invention, shown from the front left side, in an assembled stated;

FIG. 2 is an isometric view of the embodiment of FGI. 1 from the front right side;

FIG. 3 is a front elevation of the embodiment of FIG. 1;

FIG. 4 is a left side elevation of the embodiment of FIG. 1;

FIG. 5 is an isometric view of the embodiment of FIG. 1 shown in a compact storage configuration;

FIG. 6 is a top elevation of the compact storage configuration of FIG. 5;

FIG. 7 is a left side elevation of the compact storage configuration of FIG. 5; and

FIG. 8 is a front elevation of the compact storage configuration of FIG. 5.

### DESCRIPTION OF THE PREFERRED EMBODIMENTS

The present invention is a freestanding combination sink and hose reel that can be arranged in a compact storage configuration.

The principles and operation of freestanding combination sink and hose reel according to the present invention may be better understood with reference to the drawings and the accompanying description.

By way of introduction, primary features of the freestanding combination sink and hose reel of the present invention, for brevity hereafter referred to as the “workstation”, include the freestanding design of a combination sink and hose reel; a compact storage configuration; and in a preferred embodiment, the combination of a sink and hose reel, a hose reel with an automatic winding mechanism. As used herein, the term “freestanding” refers to a workstation that is structurally self-supporting and requires no support from pre-existing structures such as, but not limited to walls, fences and posts.

In the compact storage configuration, the overall dimensions of the workstation are similar to the outer dimensions of the sink element. In a preferred embodiment, the overall dimensions of the workstation in the assembled state are W 578 mm×D 526 mm×H 872 mm (to the top of the sink element), while the overall dimensions of the compact storage configuration are Width 578 mm×Depth 526 mm×Height 200 mm. In this embodiment, the present invention provides a compact storage configuration that is less than about 25 percent of the size of the assemble workstation. This is a distinct advantage for shipping since a larger number of units can be shipped in the same space needed for devices of prior art, many of which must be shipped fully assembled. Storage of the workstation of the present invention in the compact storage configuration is also beneficial for wholesalers, retailers, thereby taking up much less display space per unit. End consumers may also benefit when the workstation is not in use such as, but not limited to, during the winter months, during vacations, and when moving.

The rotatable hose reel is configured so as to nest in the sink basin when arranged in the compact storage configuration. The workstation may be configured for deployment in its compact storage configuration for initial packing, shipping and storage by wholesalers and retailers, and then permanently deployed in its freestanding assembled state by the end user. Alternatively, the workstation may be configured such that the end user may also use the compact storage configuration for storage of the workstation when not in use.

In the preferred embodiment described herein, the hose reel is configured with flanges that include a foldable section, thereby decreasing the peripheral contour of the hose reel. This is an advantage when the workstation is configured with a rectangular sink basin, in that it allows for a hose reel with a flange diameter that is only slightly less than the interior length of the sink basin.

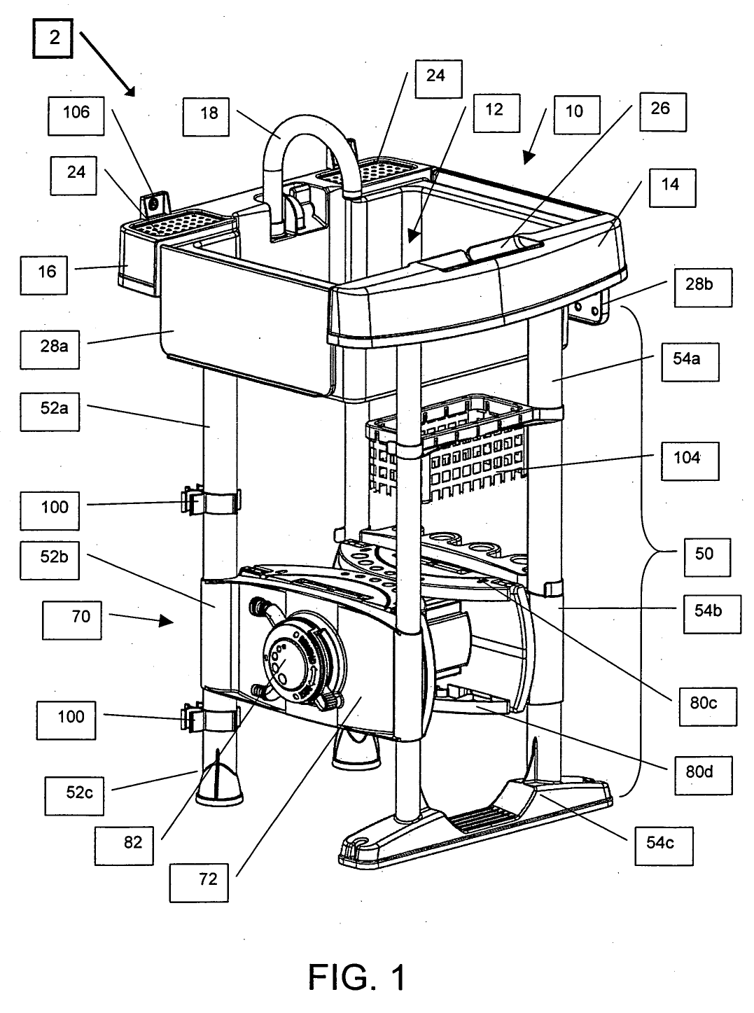

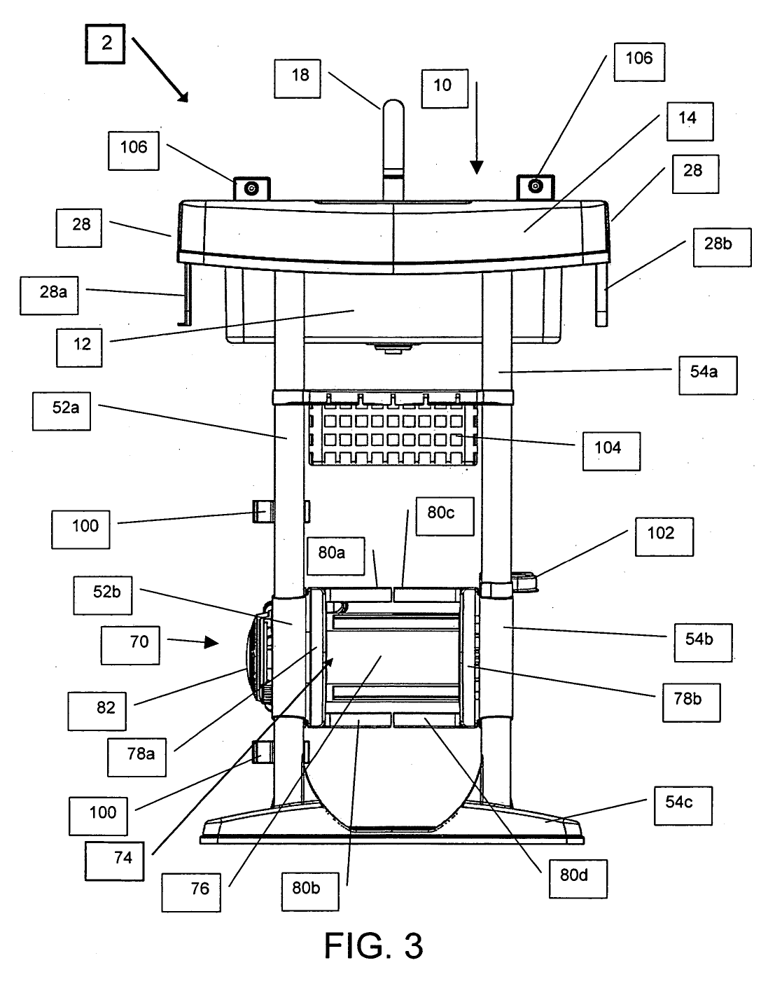

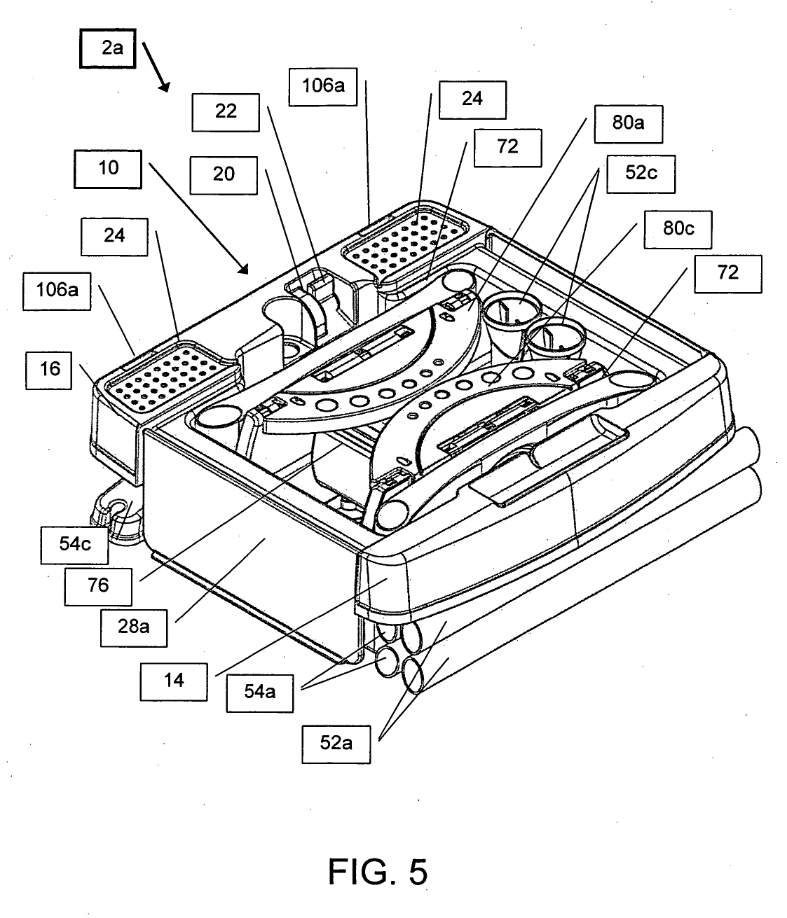

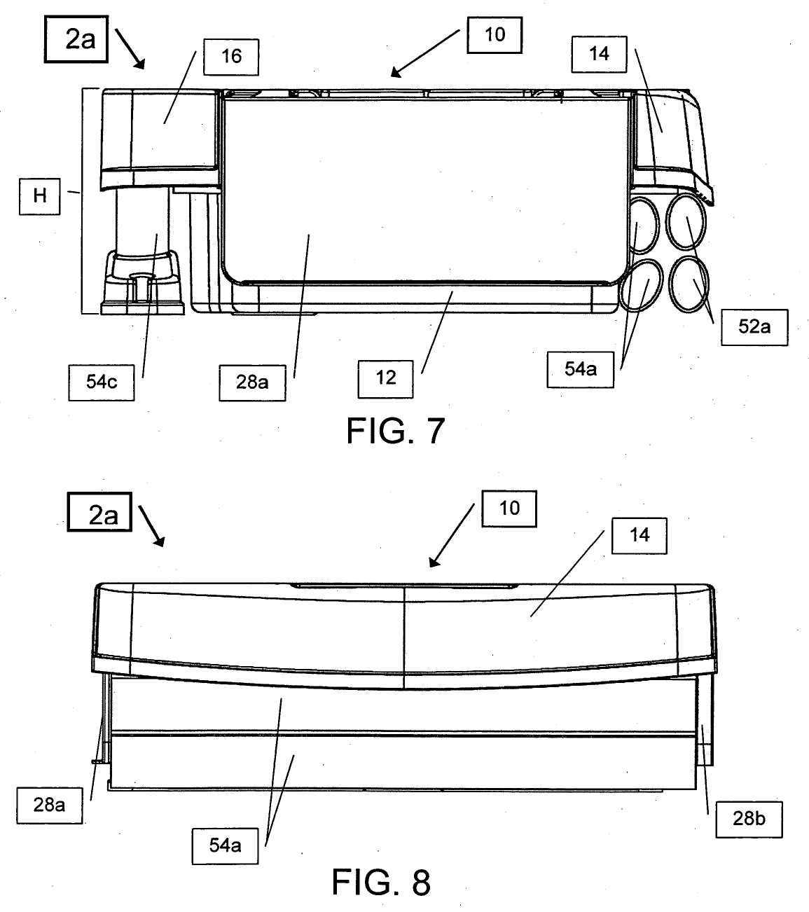

Referring now to the drawings, FIGS. 1-4 illustrate a preferred embodiment of the workstation of the present invention in an assembled state, and FIGS. 5-8 illustrate this embodiment in a compact storage configuration.

As illustrated in FIG. 1, the workstation, generally referred to throughout by reference numeral 2, may be assembled into a freestanding workstation that includes a sink element 10, segmented legs 50, and a hose reel 70, each of which will be discussed in detail below. The segmented legs 50 and the hose reel support frame 72 are combined to form a workstation stand that supports the sink element and hose reel when in the assembled state.

Water may be supplied to the workstation by connection of a conduit such as, but not limited to, a length of garden hose, thereby rendering the workstation portable. Alternatively, once assembled, the workstation may be substantially permanently deployed and attached to a conduit such as, but not limited to, a length of rigid pipe.

The sink element 10 is configured with a sink basin 12, and front and rear overhang regions 14 and 16, respectively, the undersides of which are configured for releasable connection to the segmented legs 50 substantially at each of the four corners of the sink element. Connection is preferably by friction fit of hollow leg segments over receiving stems configured on the sink element, however, substantially any known connection mechanism such as, but not limited to, threaded fittings, locking tabs, screws, nuts and bolts, and clips may be used to connect the segmented legs 50 to the sink element 10. The sink basin 12 extends below the sink element overhang regions, and both the interior and exterior of the sink basin are visible in the figures, therefore reference numerals may be directed to either the interior or the exterior of the sink basin.

A facet connection 18a is configured in the rear overhang region 16 to receive facet 18. The flow of water through facet 18 is controlled by lever 20 that is located in recess 22 so as to be below the top surface of the sink element 10.

Optionally, the overhang regions 14 and 16 may include accessory areas such as the soap holding areas 24 configured in the rear overhang region 16. The front overhang region 14 is illustrated here with an accessory recess 26.

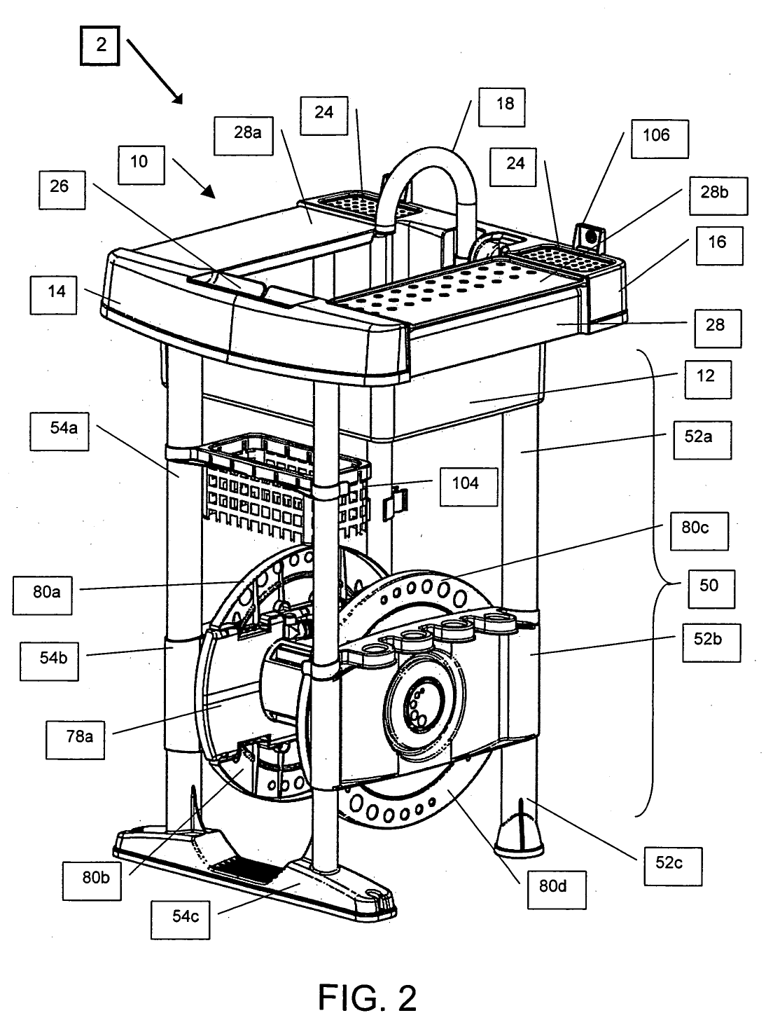

Further options to the sink element illustrated herein are rotatable work surfaces 28a and 28b that are rotatably connected to the side overhang regions 28. The rotatable work surfaces 28a and 28b are rotatable between a storage position as illustrated in FIGS. 1, 3 and 4, which the work surface hangs to the side of the sink element 10, and a work support position as illustrated in FIG. 2, in which the work surface covers a portion of the sink basin 12 and is substantially coplanar with the top surface of the sink element 10. It should be noted that deployment of each of the work surfaces is independent of the other, so that work surface 28a may be deployed in the storage position while work surface 28b is deployed in the work support position and vise versa, or both work surfaces may be deployed in the same position, as illustrated here.

The rotatable hose reel 70 includes a hose reel support frame 72 that supports a reel 74 rotatably attached to the frame. The reel 74 is rotatable about an axis of rotation. The reel 74 includes a drum 76 that circumscribes the axis of rotation and is configured to receive a length of hose coiled thereabout; and a pair of flanges 78a and 78b. Each of the flanges 78a and 78b is attached to, or integrally formed with, an opposite side of the drum 76. Each of the flanges 78a and 78b has a fixed portion rigidly associated with the drum and at least one foldable portion 80 hinged to the fixed portion so as to be displaceable between a folded state (see FIGS. 1 and 3-6) and a deployed state (see FIG. 2). As illustrated here, each flange 78a and 78b has two foldable portions 80a and 80b, and 80c and 80d respectively. When the workstation is deployed in its freestanding assembled state, the foldable portions 80a and 80b, and 80c and 80d of the flanges 78a and 78b are folded to their deployed state (FIG. 2) so as to allow for winding of a length of hose attached to the reel 74.

When deployed in the compact storage configuration, the foldable portions 80a and 80b, and 80c and 80d of the flanges 78a and 78b are folded to their folded state (FIGS. 1 and 3-6) so as to allow for nesting inside of the sink basin. The distance between the outer surfaces of each of the flanges 78a and 78b is similar to the interior depth of the sink basin such that when the flanges 78a and 78b are in their folded state and the hose reel 70 is nested inside the sink basin, the hose reel does not extend above the top surface of the sink element, as is clearly illustrated in FIGS. 5-8.

The embodiment of the hose reel 70 illustrated herein is further configured with a hydraulic motor 82 that is driven by water pressure supplied by the same water source and the water for the sink and the length of hose attached to the hose reel. The hydraulic motor 82 is operable for automatic winding of the length of hose attached to the hose reel. It will be understood that winding of the hose may be accomplished by any number of automatic or manual device configurations know in the art for performing such a task.

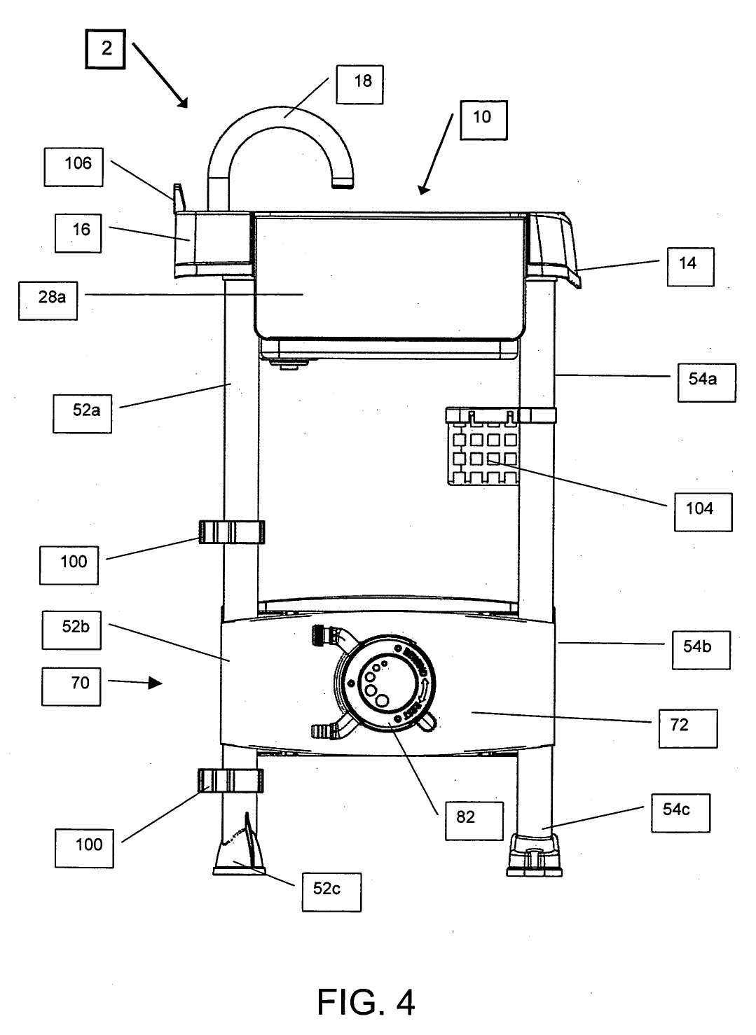

Each of the four corners of the hose reel support frame 72 is configured for releasable connection to segments of the legs, and therefore forms a portion of each of the segmented legs. FIG. 4 best illustrates the arrangement of the plurality of leg segments that form each of the segmented legs 50. Rear legs 52 are formed by the connection of leg segments 52a, 52b, which is connected to or integrally formed with the reel support frame 72, and the foot 52c. The front legs 54 are formed by the connection of leg segments 54a, 54b, which is connected to or integrally formed with the reel support frame 72, and the common front foot element 54c. Here too, connection is preferably by friction fit of one segment into the adjoining segment, however, substantially any connection configuration is within the scope of the present invention.

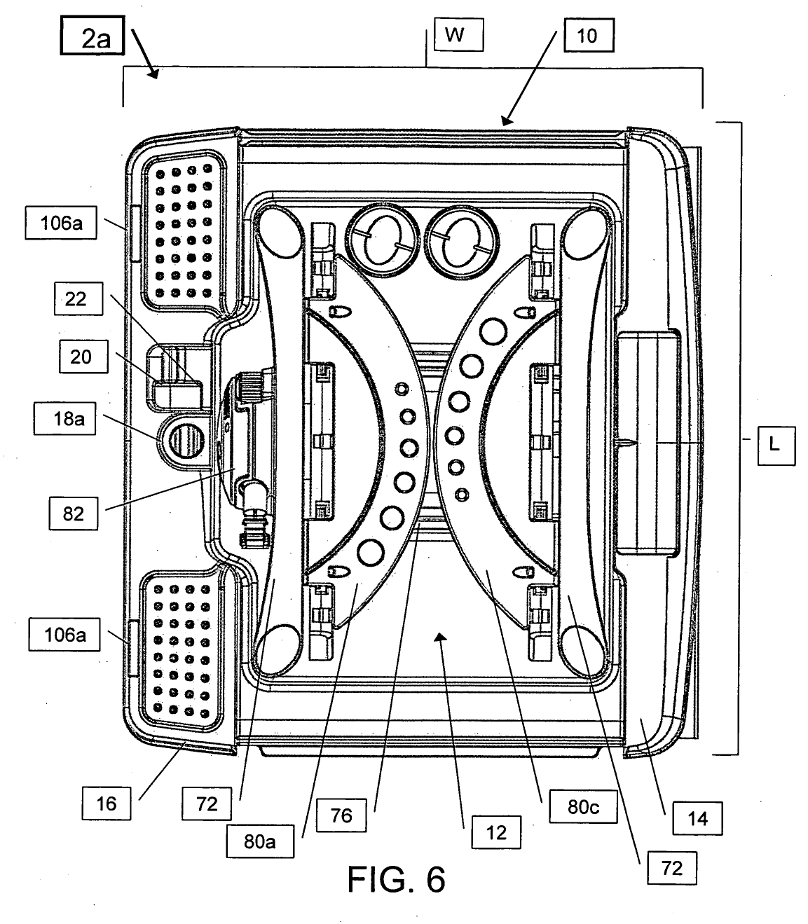

As illustrated in FIGS. 5-8, the sink element 10 has a greatest length L, a greatest width W and a greatest height H. As used herein, the phrase “overall dimensions” refers to a combination of the greatest length L, a greatest width W and a greatest height H. When the workstation 2 is arranged in its compact storage configuration, generally referred to as 2a, the overall dimensions of the compact storage configuration 2a are similar to the overall dimensions of the sink element 10 alone. That is to say, the compact storage configuration 2a of the workstation will fit into a rectangular parallelepiped that has dimensions that are similar to the overall dimensions of the sink element 10. As used herein the phrase “similar to the overall dimensions” refers to a range of 0-20 percent greater than the dimensions of the sink element 20. That is, any one or more of the dimensions of the compact storage configuration 2a are equal to or greater than the dimensions of the sink element 20, but not more than 20 percent greater. This is accomplished in the preferred embodiment illustrated herein by folding the foldable portions 80a and 80b, and 80c and 80d of the hose reel flanges 78a and 78b into their folded state and nesting the now folded hose reel 70 into the sink basin 12. The rear leg feet 52c, facet 18, and accessories such as hose retaining clips 100, tool rack 102, wall attachment elements 106 and storage basket 104 may also be nested in the sink basin 12. The common front foot 54c is positioned under the rear overhang region 16 and the remainder of the leg segments 52a and 54a are positioned under the front overhang region. As clearly illustrated in FIGS. 6-8, the overall dimensions of the compact storage configuration 2a are similar to the overall dimension of the sink element 10.

Once arranged in the compact storage configuration, the workstation 2a may be prepared for shipping by substantially any known shipping method such as, but not limited to, placement in a box, and securing the loose pieces to the sink element by packaging tape, ribbon, or cellophane.

It should be noted that for applications where the end user may wish to attach the work station to a pre-existing structure such as, but not limited to a wall, fence or post, the workstation of the present invention includes wall attachment elements 106 that may be inserted into receiving sockets 106a formed in the rear overhang region 16 of the sink element 10.

It will be appreciated that the above descriptions are intended only to serve as examples and that many other embodiments are possible within the spirit and the scope of the present invention.

What is claimed is:

1. A freestanding combination sink and hose reel workstation comprising:
(a) a sink element having a sink basin;
(b) a rotatable hose reel for storage of a length of hose; and
(c) a plurality of legs configured to form a workstation stand that supports said sink element and said rotatable hose reel.

2. The workstation of claim 1, wherein said plurality of legs are configured such that in an assembled state the workstation is freestanding.

3. The workstation of claim 1, wherein a height, width and length of the workstation in a compact storage configuration are substantially within a range of 0-20 percent greater than a height, width and length of said sink element.

4. The workstation of claim 3, wherein in said compact storage configuration said hose reel is nested in said sink basin.

5. The workstation of claim 3, wherein said plurality of legs are configured as a plurality of leg segments detachably connected to said sink element such that in said compact storage configuration at least a portion of said plurality of leg segments are nested in said sink basin and a remainder of said plurality of leg segments are stowed substantially adjacent to an exterior of said sink basin.

6. The workstation of claim 5, wherein said hose reel includes a hose reel support frame, and said hose reel support frame and said plurality of leg segments cooperate to form said workstation stand, said hose reel support frame being supported so as to allow rotation of said hose reel.

7. The workstation of claim 6, wherein at least a portion of said hose reel support frame forms at least a portion of at least one leg of said workstation stand.

8. The workstation of claim 7, wherein each of four corners of said hose reel support frame form at least a portion of each of four legs of said workstation stand.

9. The workstation of claim 1, wherein said hose reel is configured with:
(a) a hose reel support frame; and
(b) a reel rotatably attached to said frame so as to be rotatable about an axis of rotation, said reel including:
(i) a drum circumscribing said axis of rotation for receiving a length of hose coiled thereabout; and
(ii) a pair of flanges, one of said flanges being attached to, or integrally formed with, each of a first side and a second side of said drum, each of said flanges having a fixed portion rigidly associated with said drum and at least one foldable portion hinged to said fixed portion so as to be displaceable between a folded state and a deployed state;
wherein a length of said fixed portion of said flanges is less than an interior length of said sink basin and a height of said fixed portion of said flanges is less than an interior width of said sink basin such that said foldable portion of said flanges are displaced to said folded state when said hose reel is nested in said sink basin.

10. The workstation of claim 9, wherein a distance between outer surfaces of each of said flanges is less than the interior depth of said sink basin.

11. The workstation of claim 9, wherein each of said flanges has two of said foldable portions hinged to said fixed portion along substantially parallel hinges on opposite sides of said axis.

12. A freestanding combination sink and hose reel workstation comprising:
(a) a sink element having a sink basin; and
(b) a rotatable hose reel for storage of a length of hose, said hose reel detachably linked to said sink element;
wherein in a compact storage configuration said hose reel is nested in said sink basin.

13. The workstation of claim 12, wherein a height, width and length of the workstation in said compact storage configuration are substantially within a range of 0-20 percent greater than a height, width and length of said sink element.

14. The workstation of claim 12, further comprising a plurality of leg segments detachably connected to said sink element such that in said compact storage configuration at least a portion of said plurality of leg segments are nested in said sink basin and a remainder of said plurality of leg segments are stowed substantially adjacent to an exterior of said sink basin.

15. The workstation of claim 14, wherein said plurality of legs are configured such that in an assembled stated the workstation is freestanding.

16. The workstation of claim 12, wherein said hose reel includes a hose reel support frame, and said hose reel support frame and said plurality of leg segments cooperate to form a workstation stand.

17. The workstation of claim 16, wherein at least a portion of said hose reel support frame forms at least a portion of at least one leg of said workstation stand.

18. The workstation of claim 17, wherein each of four corners of said hose reel support frame form at least a portion of each of four legs of said workstation stand.

19. The workstation of claim 12, wherein said hose reel is configured with:
(a) a hose reel support frame; and
(b) a reel rotatably attached to said frame so as to be rotatable about an axis of rotation, said reel including:
(i) a drum circumscribing said axis of rotation for receiving a length of hose coiled thereabout; and
(ii) a pair of flanges, one of said flanges being attached to, or integrally formed with, each of a first side and a second side of said drum, each of said flanges having a fixed portion rigidly associated with said drum and at least one foldable portion hinged to said fixed portion so as to be displaceable between a folded state and a deployed state;
wherein a length of said fixed portion of said flanges is less than an interior length of said sink basin and a height of said fixed portion of said flanges is less than an interior depth of said sink basin such that said foldable portion of said flanges are displaced to said folded state when said hose reel is nested in said sink basin.

20. The workstation of claim 19, wherein each of said flanges has two of said foldable portions hinged to said fixed portion along substantially parallel hinges on opposite sides of said axis.

21. A freestanding combination sink and hose reel workstation comprising:
(a) a sink element having a sink basin;
(b) a rotatable hose reel for storage of a length of hose, said hose reel detachably linked to said sink element, said hose reel configured with a motor configured to actuate automatic winding of a length of hose coiled thereabout; and
(c) a workstation stand that supports said sink element and said rotatable hose reel.

22. The workstation of claim 21, wherein said motor is driven by water pressure.

23. The workstation of claim 21, wherein in a compact storage configuration said hose reel is nested in said sink basin.

24. The workstation of claim 23, wherein a height, width and length of the workstation in said compact storage configuration are substantially within a range of 0-20 percent greater than a height, width and length of said sink element.

25. The workstation of claim 24, further comprising a plurality of leg segments detachably connected to said sink element such that in said compact storage configuration at least a portion of said plurality of leg segments are nested in said sink basin and a remainder of said plurality of leg segments are stowed substantially adjacent to an exterior of said sink basin.

26. The workstation of claim 23, wherein said hose reel includes a hose reel support frame, and said hose reel support frame and said plurality of leg segments cooperate to form said workstation stand.

27. The workstation of claim 21, wherein said hose reel is configured with:
(a) a hose reel support frame; and
(b) a reel rotatably attached to said frame so as to be rotatable about an axis of rotation, said reel including:
(i) a drum circumscribing said axis of rotation for receiving a length of hose coiled thereabout; and
(ii) a pair of flanges, one of said flanges being attached to, or integrally formed with, each of a first side and a second side of said drum, each of said flanges having a fixed portion rigidly associated with said drum and at least one foldable portion hinged to said fixed portion so as to be displaceable between a folded state and a deployed state;
wherein a length of said fixed portion of said flanges is less than an interior length of said sink basin and a height of said fixed portion of said flanges is less than an interior depth of said sink basin such that said foldable portion of said flanges are displaced to said folded state when said hose reel is nested in said sink basin.

28. A method for arranging a combination sink and hose reel workstation in compact storage configuration, the method comprising:
(a) providing a breakdown workstation including:
(i) a sink element having a sink basin; and
(ii) a rotatable hose reel for storage of a length of hose, said hose reel detachably linkable to said sink element; and
(b) nesting said rotatable hose reel into an interior volume of said sink basin.

29. The method of claim 28, wherein said nesting is implemented such that a height, width and length of the compact storage configuration are substantially within a range of 0-20 percent greater than a height, width and length of said sink element.

30. The method of claim 28, further including providing a plurality of leg segments, and nesting at least a portion of said plurality of leg segments in said sink basin and stowing a remainder of said plurality of leg segments substantially adjacent to an exterior of said sink basin.

31. The method of claim 28, wherein said hose reel is implemented with:
(a) a hose reel support frame; and
(b) a reel rotatably attached to said frame so as to be rotatable about an axis of rotation, said reel including:
(i) a drum circumscribing said axis of rotation for receiving a length of hose coiled thereabout; and
(ii) a pair of flanges, one of said flanges being attached to, or integrally formed with, each of a first side and a second side of said drum, each of said flanges having a fixed portion rigidly associated with said drum and at least one foldable portion hinged to said fixed portion so as to be displaceable between a folded state and a deployed state;
wherein a length of said fixed portion of said flanges is less than an interior length of said sink basin and a height of said fixed portion of said flanges is less than an interior depth of said sink basin such that said foldable portion of said flanges are displaced to said folded state when said hose reel is nested in said sink basin.
